(19) United States
(12) Patent Application Publication
(10) Pub. No.: US 2003/0158313 A1
(43) Pub. Date: Aug. 21, 2003

(54) Antistatic additives including tetrahalogenated ionic compounds for organic polymer packaging compositions

(76) Inventor: Dennis R. Spicher, Atlanta, GA (US)

Correspondence Address: Stephen A Soffen, Dickstein Shapiro Morin & Oshinsky, 2101 L Street NW, Washington, DC, 20037-1526, US

(21) Appl. No.: 10/275,691

(22) PCT Filed: Feb. 22, 2002
(86) PCT No.: PCT/US02/05075

(51) Int. Cl. C08K 3/38; C08K 3/10

(52) U.S. Cl. 524/404; 524/437

(57) ABSTRACT

An antistatic additive includes a tetrahalogenated ionic compound. An antistatic additive composition for organic polymer compositions includes an antistatically-effective amount of the tetrahalogenated ionic compound, a solvent for the tetrahalogenated ionic compound, and a diluent compatible with the tetrahalogenated ionic compound, the solvent and the organic polymer composition. The tetrahalogenated ionic compound preferably is a tetrahalogenated borate, and more specifically lithium or sodium tetrafluoroborate. Organic polymer compositions containing the additive also are provided, as are methods incorporating the additive into the polymer compositions.

This application claims the benefit of U.S. Provisional Application Serial No. 60/270,923 filed Feb. 23, 2001.

### BACKGROUND OF THE INVENTION

1. Field of the Invention

The present invention relates to antistatic additives for chemical compositions, and, more particularly, to tetrahalogenated ionic compounds, and antistatic additives including tetrahalogenated ionic compounds for organic polymer compositions such as polyurethane and polyolefin foams and sheets.

2. Description of the Related Art

a. Commercial Applications of Organic Polymer Compositions

The explosive growth of the electronic industry over the past two decades, and the resultant necessity to protect delicate electronic components such as semiconductors, software diskettes and storage media from static electricity during manufacture and shipment has provided the impetus for the development of more sophisticated antistatic protective technologies. Such electronic components can be damaged by static discharges of less than 50 volts, and may typically experience much greater discharges (10,000 volts and up) in the normal course of manufacture and transport to end-markets. Recognition of the importance of static electricity protection by the military (particularly the U.S. Navy and Air Force) has resulted in numerous MILSPECs (including MIL-B-81705-C, MIL-P-26514-F and others) defining acceptable performance for packaging components, and these specifications have come to form the foundation for commercial antistatic components as well.

Currently, the most widely used packaging materials for electronic components include antistatic flexible polyurethane foam (both polyether and polyester) fabricated into cushioning shapes; polyolefin (generally polyethylene) sheeting and wraps; and conductive laminates fabricated into bags, sheets or containers. Knobel, in U.S. Pat. Nos. 5,068,061 (1991) and 5,110,669 (1992) gives an excellent summary of conductive polymer laminates and teaches the use of certain carbonaceous fibers and non-volatile ionizable metal salts and enhancers in such laminates. The same author, in U.S. Pat. Nos. 4,618,630 (1986) teaches the use of certain non-volatile ionizable metal salts/enhancer combinations in organic polymer compositions such as polyurethanes, as does Spicher in U.S. Pat. Nos. 5,677,357 (1997) and 5,955,526 (1999) regarding hexahalogenated ionic compounds as additives to polyurethanes, polyolefins and other organic polymer substrates.

In addition to static-dissipative packaging for electronic components, two ancillary applications for antistatic additives arise during the production of thermoset and thermoplastic materials such as flexible polyurethane foam and polyolefin sheeting. In one fabrication process (commonly called “loop slitting”) involving flexible polyurethane foam, long blocks of the material are glued end-to-end and rotated by means of a heavy conveyor system past a stationary saw blade to produce a continuous foam sheet of uniform thickness, which can then be used in furniture and bedding, automotive and carpet underlay applications. The motion of the foam block against the rubber belts and metal structure of the loop slitter creates a considerable hazard of static electricity build-up and unexpected discharge, despite mechanical grounding of the machinery. The antistatic additives taught in this patent, when incorporated in the polyurethane foam block during production significantly reduce such static build-up and sparking during the loop slitting process. In a similar manner, production of polyolefin films such as polyethylene and polypropylene by extrusion generate large static build-up which presents a similar discharge hazard for production workers. The additives taught in this patent, when incorporated in the resin during extrusion, significantly reduce this build-up and discharge, and facilitate handling and fabrication of the sheeting.

b. Industry Requirements for Static Protection

Packaging industry standards in the U.S. for static protection have developed around the MILSPECs and other trade and standards groups. These standards include:

MIL B-81705-C “Barrier Materials, Flexible, Electrostatic Protective, Heat Sealable”

This is a very comprehensive U.S. Navy specification for all types of packaging materials, not just foamed materials. Static Decay Time (less than 2 seconds) and Surface Resistivity (less than 1×10¹² ohms/sq) are the antistatic requirements of this spec. Most flexible polyurethane foams will fall under “Type II, Class 1” material. This MILSPEC includes a Contact Corrosivity requirement, affected by the type of antistatic agent employed.

MIL P-26514-F “Polyurethane Foam, Rigid or Flexible, For Packaging”

This is the major military specification for the Air Force. Antistatic requirements are for Static Decay Time of less than 2 seconds. Most foams used under this spec fit under “Type I, Class 2, Grade A”, or “Type I, Class 2, Grade C” of the spec. This MILSPEC also includes a Contact Corrosivity requirement, which is affected by the type of antistatic agent employed.

EIA 541 “Packaging Material Standards for ESD Sensitive Items”

This is a commercial spec similar in some respects to the military specs. It requires Static Decay Time of less than 2 seconds and Surface Resistivity requirements (less than 1×10¹² ohms/sq), and no contact corrosivity requirement.

NFPA 99 “Healthcare”

NFPA 77 “Static Electricity”

Others European Specification CECC 00 015/I U.S. Bureau of Mines “Electrostatic Sensitivity, Strength and No-Fire Current of Short-Delay Detonators”

Of significant note, several of these standards also specify a color code requirement for the product which denotes the density and/or type of packaging material.

c. Prior Art Antistatic Additives

As reviewed by Spicher (U.S. Pat. No. 5,677,357), the use of amine-based quaternary ammonium compounds as antistatic additives in flexible polyurethane foam fell into disfavor because of the deleterious effect of these compounds on catalysis during foam production; and their dependence on migration to the surface of the substrate at low humidity to form an antistatic barrier. Additives which depend on surface migration as the method of action contribute no volume conductivity properties to the substrate, and in the case of the quaternary ammonium additives, can cause serious contact corrosivity problems in the product being packaged.

Knobel (U.S. Pat. No. 4,618,630) describes the use of various non-volatile ionizable metal salt compositions in combination with various organic “enhancer” compounds which increase the efficacy of the relatively low-potency active species. These products have been disfavored commercially because of their relatively high cost, higher use levels required and the commercial scarcity of the active species. The most widely used of these (“the Dow additive”) is an organic boron composition that is non-migratory, non-corrosive and chemically inert with respect to the polyurethane reaction.

The hexahalogenated ionic additives described by Spicher in U.S. Pat. No. 5,677,357 are widely used at present based on their superior cost/performance, ability to impart excellent antistatic properties across a broad range of foam densities, non-migratory nature, low contribution to contact corrosivity and long-lived persistence in the foam matrix. Of concern with the hexahalogenated ionic additives is their tendency, as active electronic moieties, to interfere chemically with certain pigment and colorants (particularly reds and pinks) resulting in a bleached or discolored appearance of the foam product, usually in the center of the foam block where exotherm temperatures are highest. Aside from the ascetic considerations of non-uniform coloration in the foam block, these areas of discoloration are often accompanied by the diminution of antistatic properties in these areas. In such cases, it has been determined that replacement of the red/pink pigment or colorant with, for example, a blue or black pigment/colorant, or elimination of the pigment/colorant entirely, results in foam with no evidence of discoloration or diminished electrical properties. This would suggest that the additive may be participating chemically with the specific red/pink colorant to cause the problem observed.

### SUMMARY OF THE INVENTION

The present invention overcomes the disadvantages of the prior art, such as those noted above, by providing tetrahalogenated ionic salts as antistatic agents. The antistatic tetrahalogenated ionic salts used according to the present invention can include any of the halogens, i.e., fluorine, chlorine, bromine, iodine, or astatine. The tetrahalogenated ionic compounds having antistatic activity according to the present invention broadly include ionic salts of tetrahalogenated compounds from Group IIIA of the periodic table, i.e., boron, aluminum, galium, indium, and thallium. Tetrahalogenated ionic salts of the present invention can be formed, for example, with any of the salt-forming cations, such as ammonium, or any of the salt-forming metals or alkali metals, such as lithium, sodium, rubidium, and cesium.

In addition, according to the present invention, the tetrahalogenated ionic compound is included in an additive composition for use in chemical compositions. According to the present invention, the antistatic additive for chemical compositions includes a tetrahalogenated ionic compound, a solvent for the tetrahalogenated ionic compound, and a diluent compatible with the tetrahalogenated ionic compound, the solvent and the chemical composition.

In addition, the present invention provides an antistatic organic polymer composition and a method of making the composition in which an organic polymer composition is rendered antistatic by including the tetrahalogenated ionic compound as an antistatic additive. In a preferred embodiment, the organic polymer composition is polyurethane foam. Of course, packaging materials made up of organic polymer compositions take many other forms, including laminates, films, and elastomers which can be enhanced using the antistatic additives of the present invention. An example of an electrostatically protected laminate packaging structure is taught in U.S. Pat. No. 5,110,669 issued to Knobel et al. on May 5, 1992, the entire disclosure of which is incorporated herein by reference.

In addition to polyurethanes, the organic polymer used in the antistatic composition can be, for example, a polyolefin, polyvinyl chloride, polyvinylidene chloride, a polyester, a poly(vinyl aromatic), an acrylonitrile-butadiene-styrene polymer, a polycarbonate or a copolymer of an olefin with carbon monoxide or vinyl alcohol. The organic polymer preferably is provided in the form of a polyurethane foam.

The present invention represents a significant cost-performance improvement over the Dow additive noted above. The present invention is also non-migratory, non-corrosive and relatively inert with respect to production processing. Significantly, when added to polyurethane foam at a level of 3-5 parts per hundred parts polyol, the present invention renders the resulting polyurethane polymer static dissipative or “antistatic.” Use levels of 3-5 pphp of the present invention gives equivalent electrostatic results as the Dow additive at 8-10 parts.

Moreover, the antistatic additive of the present invention does not depend on or utilize any type of “enhancer” to achieve equivalent performance results, such as that required by the Dow additive.

The antistatic additive of the present invention also shows a much reduced tendency for chemical interaction and discoloration than the hexahalogenated ionic salts in formulations containing red or pink pigments and colorants. This allows for the production of flexible foams of uniform coloration and antistatic properties. The present invention also shows evidence of longer term stability in the polymer matrix, as evidenced by the 24 month aged surface resisitivity data presented in FIG. 2.

### BRIEF DESCRIPTION OF THE DRAWINGS

FIG. 1 is a diagrammatic cross-section of a commercially produced flexible polyether polyurethane block showing the block profile surface resistivity results using an antistatic additive according to the present invention.

FIG. 2 is a diagrammatic cross-section of a commercially produced flexible polyether polyurethane block showing the 24 month aged block profile surface resistivity results using an antistatic additive according to the present invention.

### DETAILED DESCRIPTION OF THE PREFERRED EMBODIMENTS

I. Antistatic Compound

The active antistatic compounds according to the present invention are tetrahalogenated ionic compounds. The antistatic compounds of the present invention can be described generally as the tetrahalogens of the Group IIIA elements, and salts thereof. The antistatic tetrahalogenated ionic compounds of the present invention include particularly the ammonium, lithium, sodium, potassium, rubidium, and cesium salts of tetrahalogenated boron, aluminum, gallium, indium, and thalium compounds, although salts of other cations are considered to be within the scope of the present invention. Other tetrahalogenated compounds are considered to be within the scope of the present invention, particularly those of elements from the chemically similar neighbors of Group IIIA.

The antistatic compound can be used in neat form, according to the present invention. For example, the antistatic compound can be added directly as a powder in an extrusion of polyethylene pellets. The range of the active ingredient according the present invention which is needed to render, for example, an organic polymer composition antistatic, is dependent in part upon polymer density. The higher the density of the polymer composition, the less antistatic additive is required. Effective amounts can be determined by routine experimentation by those skilled in the art.

The choice of the particular tetrahalogenated ionic compound to be used depends in part on commercial availability. Various tetrahalogenated phosphates, for example, in combination or alone, can be used as the active ingredient, lithium or sodium tetrafluoroborate being most preferred, though others are commercially available.

The criteria for choosing the most preferred active ingredient of the present invention are (a) solubility, (b) decomposition temperature, (c) halogen content, and (d) cost/performance. The sodium form at present is more commercially available and economical than the lithium analog, and exhibits an advantageous combination of better water and solvent solubility, higher fluorine content and acceptable decomposition temperature with respect to the other analogs (see Table 1; reference “The Chemistry of Boron and its Compounds”, Earl L. Muetterties, New York, Wiley, 1967, pp. 335-337.)

TABLE 1
PROPERTIES OF VARIOUS TETRAHALOGENATED BORATES

| | | | Solubility in Water |
|---|---|---|---|
| | Melting Point, ° C. | % F (theoretical) | g./100 g. water/° C. |
| LiBF₄ | Decomposes | 81.1% | Very soluble |
| NaBF₄ | 384 (decomposes) | 69.2% | 52% by wt. |
| KBF₄ | 530 (decomposes) | 60.4% | 0.448/20 |
| RbBF₄ | 590 | 44.1% | 0.55/20 |
| CsBF₄ | 550 | 34.6% | 0.92/20 |
| NH₄BF₄ | 230 (sublimes) | 73.9% | 20.3/23 |

II. Antistatic Additive Composition

The preferred antistatic additive composition of the present invention includes an antistatically-effective amount of one of the tetrahalogenated ionic compounds, upon addition of the additive to the composition to be rendered antistatic. In addition, the additive composition can include one or more co-solvents, and diluent.

A. Active Ingredient

The active antistatic ingredient for the additive composition according to the present invention is the tetrahalogenated ionic compound described above. The antistatic ionic compound of the present invention can be included in the additive composition in varying amounts. In a typical application, the ionic compound is included in an amount ranging approximately from 0.5-15% by weight of the additive composition. In a most preferred embodiment, the ionic compound of the present invention is included in the 2.25-10% range by weight of the antistatic additive composition of the present invention. The above percentages are illustrative, and may be varied depending on various factors, including the chemical formulation or type of polymer to be treated with the antistatic additive.

B. Solvent

In formulating the antistatic additive composition of the present invention, a co-solvent can be included to solubilize the active ingredient. The solvent employed can be any compound that will solubilize the active ingredient, examples of which are water, N-methyl pyrrolidone, and low molecular weight polyethylene glycol. The co-solvent, preferably N-methyl pyrrolodone, is included in the range of approximately 1.1-22% by weight of the additive composition. The co-solvent is most preferably used in the 4.5-15% range. Again, these percentages can be varied outside these ranges depending upon the requirements of the particular application.

C. Diluent

A diluent can be included in the antistatic additive of the present invention to make the active/co-solvent system compatible with the composition to be treated. The diluent can be any compound that is compatible with the active/solvent system and the composition to be rendered antistatic.

When preparing PU foams, for example, a urethane polyol is a preferred diluent. Such a polyol is completely compatible with generally-used foam formulations, and is readily available.

Other diluents can be used, including, but not limited to polypropylene glycols and triols, including dipropylene glycol; poly(oxy)propylene glycols and triols, including but not limited to glycerine and/or hexanetriol-initiated triols; and plasticizers that are not necessarily “enhancers” as that term is described in U.S. Pat. No. 4,618,630, noted above. Optionally, various enhancers, such as antistatic enhancers, including non-ionizable salts or esters of an organic acid, also can be included with the antistatic additive of the present invention.

III. Foam Productions

Flexible PU foam is produced from a mixture of chemical ingredients (mostly in liquid form; some are slurried or dispersed solid in liquid) which are brought together in a mixing head and then dispensed on a moving conveyor lined with plastic film or kraft paper.

The reaction of the polyol and isocyanate produce the solid portion of the polymer, while at the same time a competing reaction between water and isocyanate generates carbon dioxide gas, this gas giving the reaction mixture a foaming, or “cellular” quality (as opposed to solid elastomer).

The polyol-isocyanate reaction is controlled (catalyzed) by the addition of a small amount of tin-based catalyst (usually stannous octoate or dibutyl tin dilaurate), while the water-isocyanate reaction is catalyzed by a small amount of a tertiary amine-type additive. A silicone surfactant is included which stabilizes the rising foaming mass until it “cures” or solidifies into a self-supporting block.

The chemical components are delivered via pump and metering controls to the mixing head in separate streams, or in some cases certain of the components will be pre-combined (“batched”) and then delivered to the mixing head. The antistatic additive is added at this stage either as a separate component, or prebatched with one of the other components.

IV. Antistatic Foam Production and Formulations

### EXAMPLE 1

A typical 1.3 pcf, 35 Indentation Force Deflection (IFD) formulation using the present invention (commercially available from the assignee of the present invention as CELLTECH® NC-4-B Antistatic Additive) is as follows:

| | Parts per Hundred |
|---|---|
| Component | (based on polyol) |
| ALCUPOL ® F-5511 Polyol | 100 |
| (55 hydroxyl, EO/PO polyether triol) | |
| Water | 4.90 |
| CELLCAT ® 215 Amine Catalyst | 0.10 |
| Union Carbide ® L-620 Silicone Surfactant | 0.85 |
| CELLCAT ® C-2 Tin Catalyst | 0.23 |
| CELLTECH ® NC-4-B Antistatic Additive | 5.0 |
| Red Pigment | As desired |
| Toluene Diisocyanate 80/20 (105 index) | 58.65 |

| MILSPEC | Measured Static Decay Time | |
|---|---|---|
| B-81705-B | (seconds) at 74° F., | Test |
| Requirement | 15% RH, | Result |
| <2.0 | 0.045 | PASS |

| | Measured Surface Resistivity | |
|---|---|---|
| ASTM D-257 | (Ω/sq) at 74° F., | Test |
| Requirement | at 15% RH | Result |
| <1.0 × 10¹² | 2.45 × 10¹⁰ | PASS |

Concentrations of each ingredient are given based on “parts per hundred” of the polyol. The formulation is always based on “100 parts polyol”. The formulations are generally based on “100 parts polyol”. To determine the stoichiometric amount of isocyanate to be used (or in this case, an 5% excess of TDI, denoted as “105 index”), the total equivalent weight of hydroxyl functionality in the mixture is calculated (polyol, water and any other hydroxyl-containing components, since the isocyanate reacts with hydroxyl-containing ingredients) and an equivalent weight of TDI used. Note that the present invention, because it is diluted with a hydroxyl-containing compound, must be included in the stoichiometric isocyanate calculations.

Use levels of antistatic additive based on weight percent can easily be calculated by summing the total weight of all the components and expressing the antistat level in percent form. For example, the antistatic additive is used in Example 1 above at 5÷169.73=2.94% by weight.

V. Efficacy

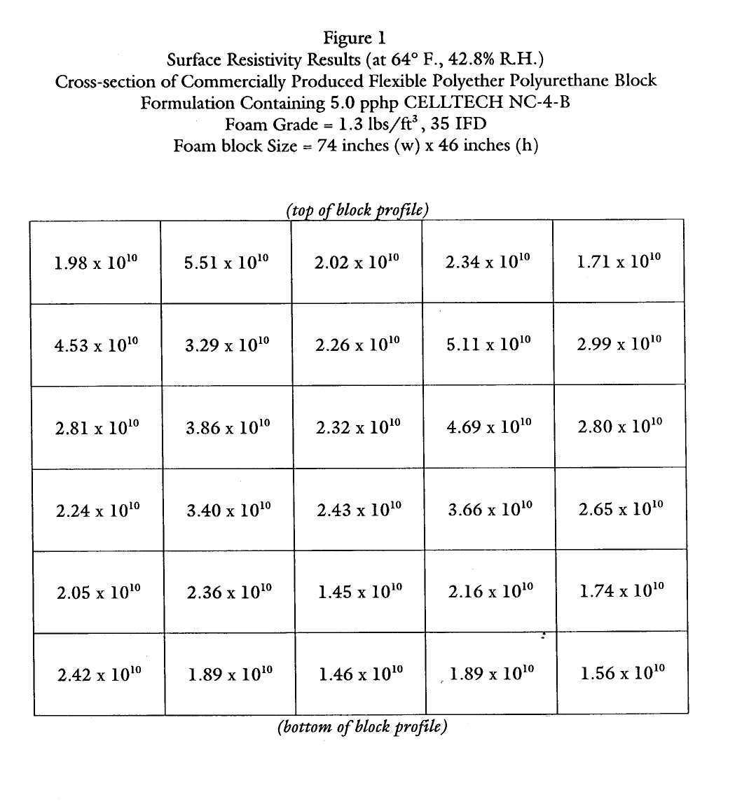

Test results demonstrate that the antistatic ionic compounds and the antistatic additive of the present invention advantageously provide a dramatic reduction in both surface and volume resistivity of greater than 80% at a 30% lower use level than the Dow additive noted above. Additionally, the present invention shows increased uniformity of antistatic properties across the foam block as compared to both the Dow additive and the hexahalogenated ionic compounds (see FIG. 1).

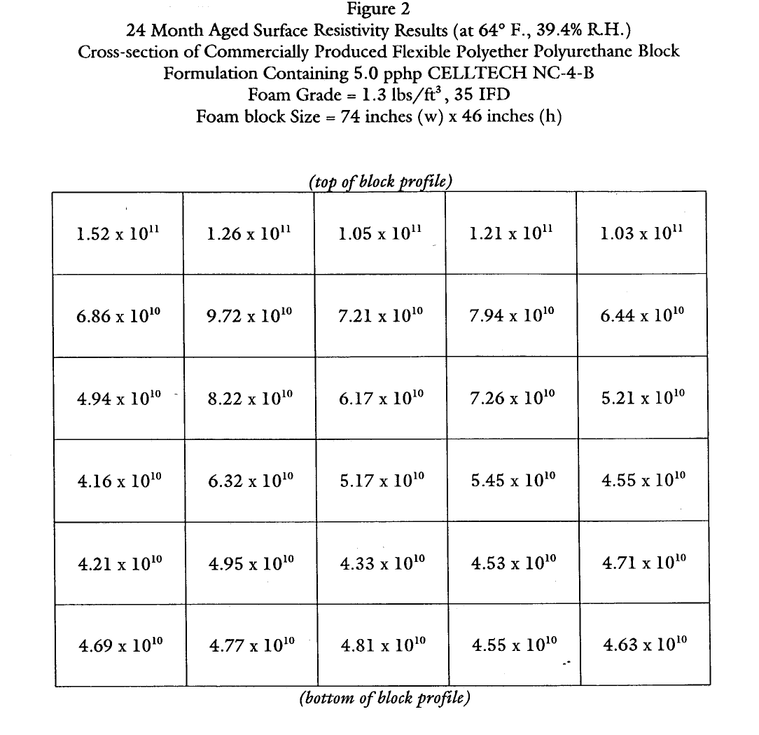

Twenty-four month aging studies of the foam produced using the 1.3 pcf, 35 IFD formulation of Example 1 showed slightly decreased antistatic performance than the original results, but still well within specifications of the MILSPEC values (see FIG. 2).

VI. Laminates

Laminate packaging for electronic components generally includes electrically conductive shielding and static dissipation. The additive of the present invention can be dispersed in an organic polymer to render packaging films electrostatically dissipative. Packages for electronic components can be constructed using one or more layers of the static dissipative films. The antistatic additive is provided in an amount that will render the organic polymer film more conductive as compared to the polymer film without the additive.

The polymer composition suitably comprises any generally non-conductive, organic polymer in which an ionizable metal salt can be dispersed. Suitable polymers include polyolefins such as polyethylene, polypropylene and polyisobutylene, ethylene-acrylic acid copolymers, polyesters, polyamides, polyvinylhalides, polystyrene and copolymers of styrene and other unsaturated monomers such as acrylonitrile/butadiene/styrene polymers, polycarbonates, polyurethanes, interpolymers of ethylene and carbon monoxide, polyethers, ethylene-vinyl acetate copolymers, ethylene-vinyl alcohol copolymers and the like. Mixtures of these and other polymers are also suitable. The polymer is suitably linear or branched, but, with either structure, is preferably thermoplastic. The polymer and the antistatic additive advantageously are selected for their mutual compatibility and for physical and chemical properties suitable for a specific application.

Although the present invention has been described in relation to particular embodiments thereof, many other variations and modifications and other uses will become apparent to those skilled in the art. Therefore, the present invention is to be limited not by the specific disclosure herein, but only by the appended claims.

What is claimed is:

1. An organic polymer composition stabilized against static comprising:
an organic polymer; and
an antistatically-effective amount of a tetrahalogenated ionic compound of the form AMX₄, where A is inorganic, and is a salt-forming cation or a salt-forming alkali metal; M is an element, or a compound containing an element, the element being selected from Group IIIA of the periodic table; and X is a halogen.

2. The organic polymer composition of claim 1, further comprising a solvent for the tetrahalogenated ionic compound.

3. The organic polymer composition of claim 2, further comprising a diluent compatible with the tetrahalogenated ionic compound, the solvent and the organic polymer.

4. The organic polymer composition of claim 1, wherein the organic polymer is in the form of one of a film, an elastomer, or a foam.

5. The organic polymer composition of claim 1, wherein the organic polymer is a polyolefin.

6. The organic polymer composition of claim 5, wherein the organic polymer is one of foamed or foamable, elastomeric, or a film.

7. The organic polymer composition of claim 1, wherein the organic polymer is a polyurethane.

8. The organic polymer composition of claim 6, wherein the polyurethane is one of foamed or foamable elastomeric, or a film.

9. The organic polymer composition of claim 1, wherein the organic polymer is formed as a packaging film.

10. An organic polymer composition stabilized against static comprising:
an organic polymer; and
about 0.5% to about 15% by weight of a tetrahalogenated ionic compound of the form AMX₄, where A is a salt-forming cation or a salt-forming alkali metal; M is an element, or a compound containing an element, the element being selected from Group IIIA of the periodic table; and X is a halogen.

11. The organic polymer composition of claim 10, further comprising a solvent for the tetrahalogenated ionic compound.

12. The organic polymer composition of claim 11, further comprising a diluent that is compatible with the organic polymer, the tetrahalogenated ionic compound, and the solvent.

13. The organic polymer composition of claim 10, wherein the organic polymer is polyurethane.

14. The organic polymer composition of claim 13, wherein the polyurethane is foamed or foamable.

15. An organic polymer composition stabilized against static comprising:
a polyurethane; and
an antistatically-effective amount of a tetrahalogenated ionic compound of the form AMX₄, where A is inorganic, and is a salt-forming cation or a salt-forming alkali metal; M is an element, or a compound containing an element, selected from Group IIIA of the periodic table.

16. The organic polymer composition of claim 15, further comprising a solvent for the tetrahalogenated ionic compound, and a diluent compatible with the polyurethane, the tetrahalogenated ionic compound, and the solvent.

17. The organic polymer composition of claim 15, wherein the polyurethane is in the form of a foam, an elastomer, or a film.

18. A method of imparting antistatic properties to a foamed polyurethane composition that comprises the steps of:
adding an antistatically effective amount of an inorganic tetrahalogenated ionic compound to a polyurethane formulation; and
foaming the polyurethane formulation to produce the foamed polyurethane composition.

19. The method of claim 18, wherein the inorganic ionic compound is selected from the group consisting of tetrahalogens of the Group IIIA elements, and salts thereof.

20. The method of claim 18, wherein the inorganic ionic compound is selected from the group consisting of metal salts of boron, aluminum, gallium, indium, and thallium compounds.

21. The method of claim 18, wherein the inorganic tetrahalogenated ionic compound is added in the form of a solution.

22. The method of claim 18, wherein inorganic tetrahalogenated ionic compound is a salt of lithium or sodium.

23. The method of claim 18, wherein the inorganic tetrahalogenated ionic compound is of the form AMX₄, where A is a salt-forming cation, a salt-forming metal, or a salt-forming alkali metal; M is an element, or a compound containing an element, the element being selected from Group IIIA of the periodic table, and X is a halogen.

24. A method of imparting antistatic properties to a polyurethane composition, the method comprising the step of adding to the polyurethane composition an antistatically effective amount of an inorganic tetrahalogenated ionic compound of the form AMX₄, where A is a salt-forming cation or a salt-forming alkali metal; M is an element, or a compound containing an element, the element being selected from Group IIIA of the periodic table; and X is a halogen.

25. The method of claim 24, wherein the inorganic tetrahalogenated ionic compound is added in the form of a solution.

26. The method of claim 24, wherein the polyurethane composition is provided in the form of a foam, an elastomer, or a film.
